(19) United States
(12) Patent Application Publication
(10) Pub. No.: US 2024/0248455 A1
(43) Pub. Date: Jul. 25, 2024

(54) METHODS, SYSTEMS, AND COMPUTER PROGRAM PRODUCTS FOR PROACTIVE THERMAL MANAGEMENT AND PROCESSING CORE SELECTION

(71) Applicant: Mellanox Technologies, Ltd., Yokneam (IL)

(72) Inventors: Tahir Cader, Spokane Valley, WA (US); Siddha Ganju, Santa Clara, CA (US); Avraham Ganor, Shoham (IL); Ran Hasson Ruso, Tel Aviv (IL); Elad Mentovich, Tel Aviv (IL)

(21) Appl. No.: 18/100,296

(22) Filed: Jan. 23, 2023

(51) Int. Cl. G05B 19/4155

(52) U.S. Cl. CPC G05B 19/4155; G05B 2219/49216

(57) ABSTRACT

Methods, apparatuses, and computer program products for proactive thermal management and processing core selection are provided. An example method includes receiving a job packet that is associated with a packet profile and determining one or more performance parameters associated with a performance of the job packet as defined by the packet profile. The method further includes generating a proactive thermal management procedure based upon the one or more performance parameters and associating the proactive thermal management procedure with the job packet. The method may further include determining a selected processing core from amongst a plurality of processing cores for the performance of the job packet based upon one or more operating characteristics of the processing cores and/or one or more performance parameters of the job packet.

### TECHNOLOGICAL FIELD

Embodiments of the present disclosure relate generally to networking and computing systems, and, more particularly, to the dynamic selection of processing cores and proactive thermal management in distributed networking and computing environments.

### BACKGROUND

Distributed networking and computing environments may utilize or otherwise access a plurality of processing cores that complete operations defined by job packets (e.g., tasks, requests, actions, applications, transactions, etc.). Each of these processing cores may have distinct operational capabilities, and the operations performed by these processing cores may further be associated with varying thermal burdens. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure provide for methods, systems, apparatuses, and computer program products for dynamic selection of processing cores and proactive thermal management in distributed networking and computing environments. With reference to an example method, the method may include receiving a job packet that is associated with a packet profile and determining one or more performance parameters associated with a performance of the job packet as defined by the packet profile. The method may further include generating a proactive thermal management procedure based upon the one or more performance parameters and associating the proactive thermal management procedure with the job packet.

In some embodiments, the method may further include determining a selected processing core from amongst a plurality of processing cores for the performance of the job packet and transmitting the job packet to the selected processing core.

In some further embodiments, determining the selected processing core may further include receiving one or more operating characteristics of each of the plurality of processing cores and determining the selected processing core based upon the one or more operating characteristics and the one or more performance parameters of the job packet.

In some embodiments, the proactive thermal management procedure may be configured to cause dissipation of heat associated with the selected processing core that is generated in response to the performance of the job packet.

In some embodiments, the proactive thermal management procedure may be configured to dynamically modify a supplied cooling amount based upon variation in the one or more operating characteristics of the selected processing core during performance of the job packet.

In some further embodiments, a maximum supplied cooling amount may coincide with a maximal thermal load of the selected processing core during performance of the job packet.

In some embodiments, the method may further include modifying the proactive thermal management procedure in response to the performance of the job packet by the selected processing core.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example distributed computing system for implementing one or more embodiments of the present disclosure;

FIG. 2 illustrates a block diagram of example server circuitry (e.g., thermal management unit circuitry) that may be specifically configured in accordance with an example embodiment of the present disclosure;

FIG. 3 illustrates a flowchart of an example method for proactive thermal management, in accordance with some embodiments of the present disclosure; and

FIG. 4 illustrates a flowchart of an example method for processing core selection, in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As the demand for high performance computing systems increases, the need for additional computational capacities similarly increases. These increases in computing power, however, often result in increased power consumption (e.g., >1 kW) and an increase in heat emission, such as from electrical boards. Current cooling technology for datacenters often rely upon air-based cooling that is generically supplied to the racks within the datacenter for cooling the rack heat sources and carrying the excessive heat out of the rack. These conventional systems, however, have limited ability to selectively adapt the cooling to specific component needs within the datacenter and are further reactive in nature. For example, these conventional systems may supply additional cooling only in response to the determination of an increase in heat generation, and this increased cooling is not supplied to any particular components. Furthermore, conventional systems fail to dynamically direct job packets to particular network components by accounting for the associated workload of the component (e.g., processing core) and/or the thermal burden or impact associated with performance of the job packet.

To solve these issues and others, the embodiments of the present disclosure provide a proactive mechanism for dissipating heat in datacenter environments and a dynamic method for directing job packets to distributed processing cores that account for the thermal burden associated with performance of the job packet. For example, as part of profiling a particular job, various performance parameters may be determined that are representative of the thermal burden associated with a forthcoming performance of the job. The embodiments of the present disclosure may leverage these parameters to generate a proactive thermal management procedure that defines the amount of cooling, the time for which the amount is supplied, etc. in order to provide an optimized cooling solution that is job specific. For example, the thermal management procedure for a particular job may require a maximum cooling amount during peak performance times. The embodiments of the present disclosure may further dynamically determine particular processing core(s) for performance of a particular job based upon the various operational characteristics (e.g., current/expected thermal burden, current/expected utilization, and/or the like) associated with these processing cores.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Proactive Thermal Management and Processing Core Selection System

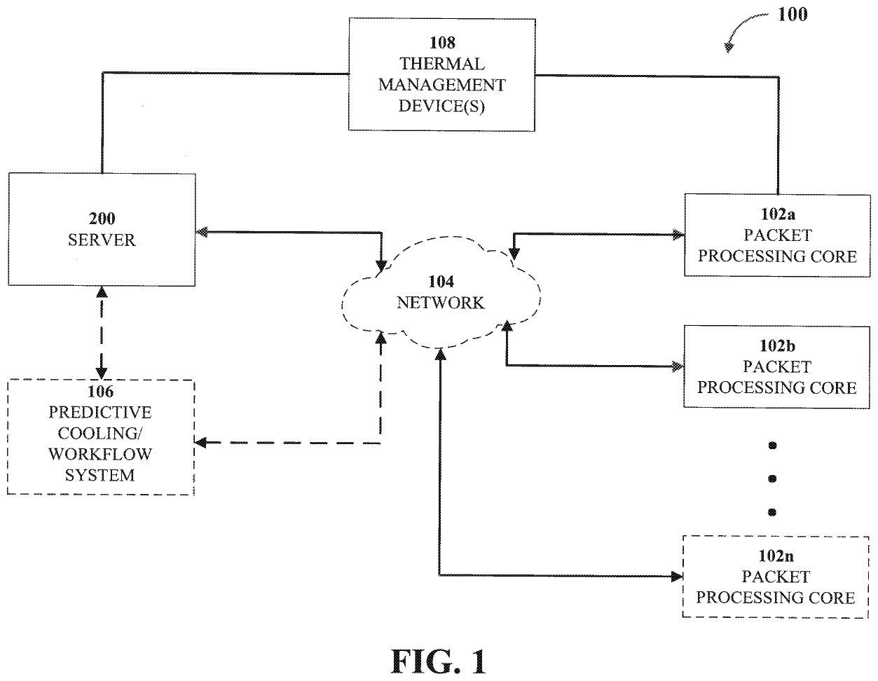

FIG. 1 illustrates a proactive thermal management and processing core selection system 100 (e.g., system 100) as an example system for managing the distribution of job packets in a computing system. It will be appreciated that the system 100 is provided as an example of an embodiment(s) and should not be construed to narrow the scope or spirit of the disclosure. The depicted system 100 of FIG. 1 may include a server 200 (e.g., a thermal management unit) capable of receiving, generating, accessing, or otherwise directing job packets from communicatively connected sources. The server 200 may be further communicatively connected to two or more packet processing cores 102a-n (e.g., a plurality of processing cores 102a-102n) by a communication network 104. The communication network 104 may also support the transmission of operating characteristics. The server 200 may, in some embodiments, be communicatively connected to a predictive cooling/workflow system 106 and/or one or more thermal management device(s) 108. For example, the server 200 may be configured to proactively cause distribution of cooling (e.g., liquid, air, etc.) from the one or more thermal management devices 108 to dissipate heat generated by the packet processing cores 102a-n.

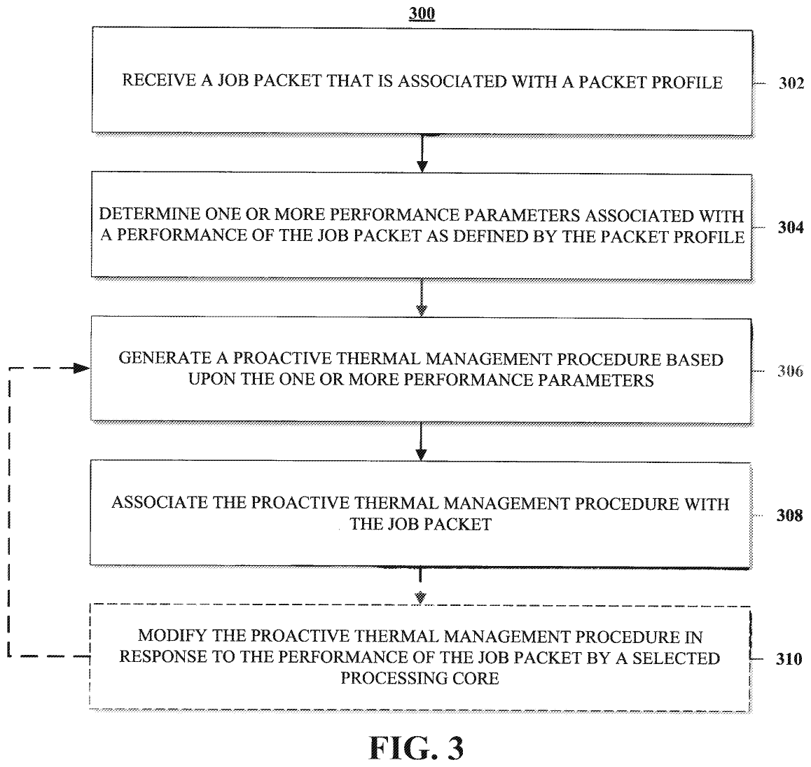

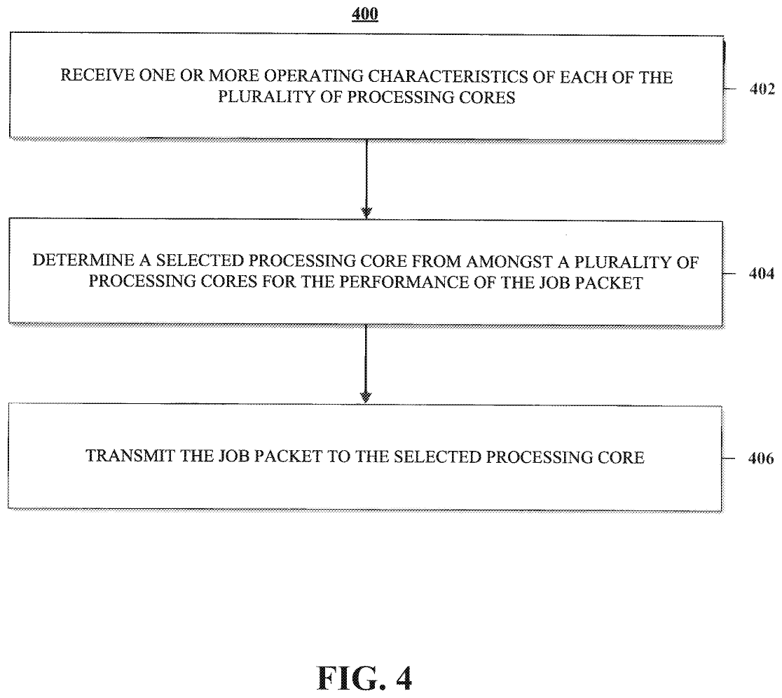

Although described hereinafter with reference to a server 200, the present disclosure contemplates that the operations described hereafter with reference to FIGS. 3-4 may be performed by any computing device, system orchestrator, central processing unit (CPU), graphics processing unit (GPU), data processing unit (DPU), and/or the like. Furthermore, although illustrated as a single device (e.g., server 200), the present disclosure contemplates that any number of distributed components may collectively be used to perform the operations described herein. As described herein, the server 200 may be configured to receive job packets from any number of sources communicably coupled with the server 200, and the server 200 may operate to direct the job packet for processing by a packet processing core 102 (or a plurality of packet processing cores 102). As described hereinafter, the thermal load or burden associated with performance of the job packet may further be considered by the server 200, and the server 200 may operate to proactively generate a thermal management procedure (e.g., with the thermal management device(s) 108) and may further select a particular processing core 102 based at least in part upon this thermal load or burden. The server 200 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The system 100 further may further include the plurality of packet processing cores 102a-n as described above. Each packet processing core 102 may be communicatively connected to the server 200 through a communication network 104 and may be configured to receive job packets from the server 200 and/or from other sources at the direction of the server 200. Each packet processing core 102 may be configured to decode, process, and carry out any actions related to the received job packet. A packet processing core 102 may be capable of monitoring, determining, and/or communicating operating characteristics relative to the utilization and operation of the packet processing core 102. For example, a packet processing core 102 may be capable of determining the processor utilization, the physical distance between the server 200 and the packet processing core 102, the number of network nodes between the server 200 and the packet processing core 102, the total and available memory capacity or memory utilization, the processing power or utilization, the operating temperature, the expected operating temperature, the security state, the power state, and/or other parameters, characteristics, attributes, etc. related to the operation of the packet processing core 102. In some embodiments, one or more of the operating characteristics may be configured by a user or an external source. A packet processing core 102 may be further capable of transmitting the collected operating characteristics to the server 200 through the communication network 104.

Each packet processing core 102 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. In some embodiments, one or more of the packet processing cores 102 may be embodied on the same physical device as the server 200. In some embodiments, one or more of the packet processing cores 102 may be remote to the system 100. Still, in some embodiments, one or more packet processing cores 102 may be located on the same physical device as the system 100 and one or more packet processing cores 102 may be remote to the system 100 and connected through a communication network 104.

The communication network 104 may be any means including hardware, software, devices, or circuitry that is configured to support the transmission of computer messages between system nodes. For example, the communication network 104 may be formed of components supporting wired transmission protocols, such as, digital subscriber line (DSL), Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 104 may be comprised of any combination of the above mentioned protocols. In some embodiments, such as when the packet processing cores 102a-n and the server 200 are formed as part of the same physical device, the communication network 104 may include the on-board wiring providing the physical connection between the component devices.

In order to proactively dissipate heat generated by the processing cores 102 (e.g., via a generated proactive thermal management procedure that is job packet specific), the system 100 may include one or more thermal management devices 108 that are communicably coupled with the server 200 and the plurality of packet processing cores 102a-n. The thermal management devices 108 may include any number of fluid-based, air-based, etc. cooling solutions that operate to dissipate heat generated by the packet processing cores 102a-n. For example, the thermal management devices 108 may include one or more air cooling components (e.g., fans, vortex tubes, pumps, plenums, etc.) that, in response to instructions from the server 200, cause air to be circulated (e.g., via one or more channels, ducts, conduits, etc.) to the plurality of packet processing cores 102a-n to selectively cause heat dissipation. Similarly, the thermal management devices 108 may include one or more fluid cooling components (e.g., pumps, radiators, water blocks, reservoirs, etc.) that, in response to instructions from the server 200, cause fluid or liquid to be circulated (e.g., via one or more channels, ducts, conduits, etc.) to the plurality of packet processing cores 102a-n to selectively cause heat dissipation. Although described herein with reference to air and/or liquid cooling solutions, the present disclosure contemplates that any mechanism, structure, devices, etc. (e.g., heat sinks, heat exchangers, and/or the like) may be used by the thermal management devices 108 to dissipate heat generated by the one or more packet processing cores 102a-n. As described herein, the heat dissipation provided by the thermal management devices 108 may be component or device specific in that the thermal management device 108 may selectively and proactively apply the heat dissipation solution to a particular packet processing core 102a-n.

In some embodiments, the system 100 may further include predictive cooling/workflow system 106. The predictive cooling/workflow system 106 may be any machine learning (ML) module, neural network, artificial intelligence based system, and/or the like capable of receiving inputs and generating a system action based on those inputs. In some embodiments, the predictive cooling/workflow system 106 may include a supervised or an unsupervised ML algorithm, for example, a reinforcement learning (RL) algorithm. The example RL algorithm may receive as inputs information gathered from a packet profile defining one or more performance parameters and/or one or more operating characteristics of the plurality of processing cores 102a-n. For example, the predictive cooling/workflow system 106 may consider the number of packets associated with the job packet, the type of data contained in the data packets, the source of the job packet, the size of the job packet, the frequency of the job packets, the protocol associated with the job packet, the encoding of the job packet, the packet data category and associated priority; the processor utilization, memory utilization, and power state of each of the packet processing cores 102a-n; the temperature of any of the components described herein, the security state, and/or the like. These received inputs indicate performance parameters associated with a performance of the job packet (e.g., as defined by a packet profile) and represent the state of the environment (e.g., the operating characteristics of the plurality of packet processing cores 102a-n). Based on the performance parameters of the job packet and the one or more operating parameters of the plurality of processing cores 102a-n, a policy may be generated. In some embodiments, the policy may be a determination of the network node (e.g., processing core) preferred for processing a job packet. In addition, the predictive cooling/workflow system 106 may receive performance data from the packet processing cores 102a-n, such as power consumption and latency. This performance data (e.g., operating characteristics) may represent the reward function of the reinforcement learning algorithm. Utilizing reinforcement learning techniques, including exploration and exploitation policies, the predictive cooling/workflow system 106 may initialize and update a policy dictating the scheduling of job packets. Such operations may be iteratively performed so as to modify generation of proactive thermal management procedures so as to iteratively improve heat dissipation and/or processing core selection.

Although the predictive cooling/workflow system 106 is described primarily in the context of an RL algorithm, it should be understood that any of a variety of artificial intelligence techniques and/or learning mechanisms may be utilized, including Model Predictive Control, Genetic Algorithms, Particle Swarm Optimization, Simulated Annealing, grid search, and/or a variety of other techniques and methodologies to supervised or unsupervised learning, to determine a particular packet processing core for completion of a particular job packet. Furthermore, the embodiments described herein may leverage one or more artificial neural networks, convolutional neural networks, generative adversarial networks, recurrent neural networks, etc. based upon the intended application of the predictive cooling/workflow system 106.

### Example Server Circuitry

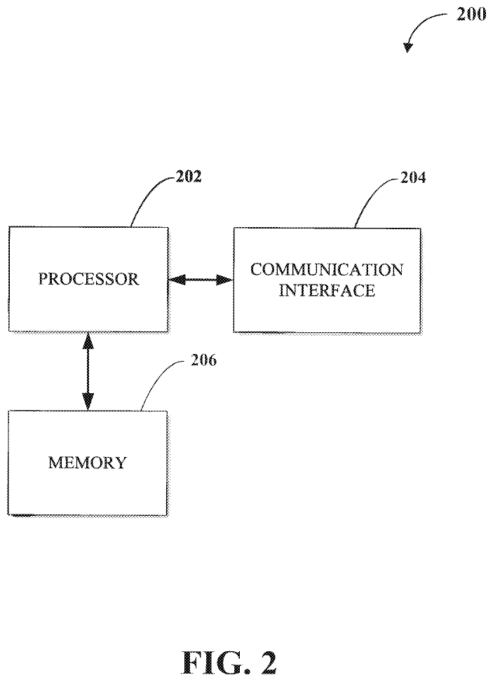

With reference to FIG. 2, example circuitry components of the server 200 are illustrated that may, alone or in combination with any of the components described herein, be configured to perform the operations described herein with reference to FIGS. 3-4. As shown, the server 200 may include, be associated with or be in communication with processor 202, a memory 206, and a communication interface 204. The processor 202 may be in communication with the memory 206 via a bus for passing information among components of the server 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202.

The server 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the server 200 may provide or supplement the functionality of particular circuitry.

### Example Method for Proactive Thermal Management

FIG. 3 illustrates a flowchart containing a series of operations for proactive thermal management. The operations illustrated in FIG. 3 may, for example, be performed by, with the assistance of, and/or under the control of an apparatus (e.g., server 200), as described above. In this regard, performance of the operations may invoke one or more of processor 202, memory 206, and/or communication interface 204.

As shown in operation 302, the apparatus (e.g., server 200) includes means, such as communication interface 204, or the like, for receiving a job packet. The job packet may, in some embodiments, be generated by the server 200 for subsequent transmission to a particular packet processing core 102a-n for performance. In such an embodiment, the receipt of the job packet at operation 302 may refer to operations associated with generation of the job packet by the server 200 (e.g., receipt of an internal transmission or the like). In other embodiments, the server 200 may receive the job packet from one or more other sources (e.g., computing devices or the like) communicably coupled with the server 200, such as via the network 104. As described herein, the job packet may refer to a collection of operations to be performed by a packet processing core 102a-n. In some embodiments, the job packet may define the operations to be performed (e.g., one or networking operations, one or more artificial intelligence algorithms, etc.). In other embodiments, the job packet may define a particular outcome or result, and the operations associated with achieving this outcome or result may be dynamically determined by the particular packet processing core 102a-n that receives the job packet. The present disclosure contemplates that the job packets described herein may refer to any operation, computation, algorithm performance, visualization generation, and/or the like without limitation. As described hereinafter with reference to operation 304, the job packet may be associated with a packet profile that at least partially defines performance parameters associated with a performance of the job packet as defined by the packet profile.

As shown in operation 304, the apparatus (e.g., server 200) includes means, such as processor 202, or the like, for determining one or more performance parameters associated with a performance of the job packet as defined by the packet profile. The packet profile may refer to the various attributes, characteristics, parameters, etc. associated with the job packet. By way of a non-limiting example, the packet profile may include data indicative of the size of the job packet, the category (e.g., type of operation(s)) of the job packet, the source of the job packet, the amount of packets associated with the job packet, the time associated with performance of one or more operations associated with the job packet, a protocol associated with the job packet, an encoding associated with the job packet, and/or the like. The present disclosure contemplates that the packet profile may include data indicative of any parameter relevant to performance of the job packet without limitation. In some embodiments, the packet profile may be generated in response to profiling a particular job (e.g., job packet) by a user. Additionally or alternatively, the server 200 may generate at least a portion of the data defined by the packet profile (e.g., automatically and/or in response to a user input).

With continued reference to operation 304, the server 200 may determine one or more performance parameters associated with a performance of the job packet based upon the various attributes, characteristics, parameters, etc. associated with job packet (e.g., defined by the packet profile). As would be evident to one of ordinary skill in the art in light of the present disclosure, the processing power utilized, the memory utilized, the time required, etc. to complete the various operations associated with the job packet may vary based upon the nature (e.g., type, category, etc.) of the job packet. By way of a non-limiting example, the processing power required to complete operations of a job packet associated with completion of complex artificial intelligence modeling and/or rendering virtual reality imaging may be greater than the processing power required to complete operations of a job packet associated with network switching. Additionally or alternatively, the priority or urgency associated with performance of a particular job packet may further implicate the performance parameters associated with performance of the job packet. For example, performance of a job packet having a high priority (e.g., relative to other job packets) may be more computationally intensive (e.g., require more processor utilization) in order to complete the job packet in a timely manner (e.g., complete the operations in a time period that satisfies the associated priority). As described hereafter with reference to FIG. 4, the operating characteristics of the plurality of packet processing cores 102a-n may further implicate the performance parameters associated with a performance of the job packet.

With regard to the particular job packet received at operation 302, the server 200 may determine one or more performance parameters associated with a performance of the job packet that may impact or otherwise be related to the thermal burden (e.g., heat generated) in performance of the operations defined by the job packet. By way of example, the server 200 may determine a time parameter, a processor utilization, and/or a memory utilization associated with performance of the operations associated with the job packet due to the impact each of these parameters may have on the thermal burden (e.g., heat generated) of the packet processing core 102a-n. In some embodiments, this determination may be based at least in part upon one or more user inputs. For example, as part of profiling the job packet or otherwise, a user may input a particular processing time, processor utilization, etc. that is to be associated with the job packet (e.g., stored in the packet profile). Additionally or alternatively, the server 200 may determine the one or more performance parameters based upon one or more prior iterations of the method 300 as described hereafter with reference to operation 310. By way of example, the server 200 may access a database or equivalent repository of proactive thermal management procedure determinations to identify one or more job packets that are similar (e.g., based upon packet profile comparison) to the job packet received at operation 302. The server may determine the one or more performance parameters based at least in part upon these prior procedure determinations. In some embodiments, the server may leverage one or more machine learning or artificial intelligence techniques as described above with reference to the predictive cooling/workflow system 106. As will be described hereinafter with reference to FIG. 4, the thermal burden may be packet processing core specific in that each packet processing core 102a-n may include varying operating characteristics (e.g., current processor/memory utilization, current temperature, etc.) that implicate particular performance of the job packet received at operation 302.

Thereafter, as shown in operation 306, the apparatus (e.g., server 200) includes means, such as processor 202, predictive cooling/workflow system 106, or the like, for generating a proactive thermal management procedure based upon the one or more performance parameters. As described above, the proactive thermal management procedure may be configured to cause dissipation of heat associated with the selected processing core that is generated in response to the performance of the job packet. As such, the server 200 may be configured to proactively determine the necessary amount of cooling sufficient to effectively dissipate heat generated by the packet processing core 102a-n when the packet processing core 102a-n performs the job packet at a future time. In some embodiments, the proactive thermal management procedure may define an amount of time during which the thermal management devices 108 may operate (e.g., supply air cooling, liquid cooling, etc.). Additionally, the proactive thermal management procedure may also define a magnitude (e.g., measure in temperature, temperature differential, etc.) of cooling to be supplied by the thermal management devices 108. In some embodiments, the proactive thermal management procedure may define the heat dissipation (e.g., cooling) provided by the thermal management devices 108 in units having a defined magnitude and/or duration. In such an embodiment, the server 200 may generate a proactive thermal management procedure that orders an amount of cooling units from the thermal management devices 108 that corresponds to the heat dissipation (e.g., cooling) to be provided to the packet processing core 102a-n that is assigned the job packet.

As would be evident to one of ordinary skill in the art in light of the present disclosure, the thermal burden (e.g., heat generated) experienced by the packet processing core 102a-n may vary during performance of the operations associated with the job packet. By way of example, the heat generated by the packet processing core 102a-n may include a maximum value (e.g., a maximal thermal load) during which processor utilization is maximized. By way of an additional example, the thermal load (e.g., heat generated) by the packet processing core 102a-n may be minimized during ramp up or loading of the job packet prior to commencing performance. In any embodiment, the proactive thermal management procedure may proactively account for any variability in thermal load during performance of the operations associated with the job packet such that cooling is supplied that increases when the thermal burden or load increases, and the cooling that is supplied decreases when the thermal burden or load decreases. By way of a particular example, a maximum supplied cooling amount from the thermal management device 108 as defined by the proactive thermal management procedure may coincide with a maximal thermal load of the selected processing core during performance of the job packet. As described hereinafter with reference to operation 310, the server may further operate to dynamically modify the proactive thermal management procedure in response to performance of the operations associated with the job packet.

Thereafter, as shown in operation 308, the apparatus (e.g., server 200) includes means, such as processor 202, predictive cooling/workflow system 106, or the like, for associating the proactive thermal management procedure with the job packet. Given the proactive nature of the thermal management solutions described herein, the proactive thermal management procedure may commence at future time that substantially corresponds with performance of the operations associated with the job packet. As such, the proactive thermal management procedure may be associated with the job packet for such further performance. By way of example, the packet profile may be updated to include the proactive thermal management procedure. By way of an additional example, the server 200 may transmit the proactive thermal management procedure to the thermal management devices 108 with an indication of the association with the job packet.

In some embodiments, as shown in operation 310, the apparatus (e.g., server 200) includes means, such as processor 202, predictive cooling/workflow system 106, or the like, for modifying the proactive thermal management procedure in response to the performance of the job packet by the selected processing core 102a-n. As described above, the server 200 may, via the predictive cooling/workflow system 106 or otherwise, operate to iteratively improve operation and/or dynamically alter thermal management operations. By way of example, the thermal load, burden, etc. experienced by the packet processing core 102a-n performing the operations of the job packet may change (e.g., increase or decrease) such that the cooling supplied to the packet processing core 102a-n as defined by the proactive thermal management procedure is inaccurate (e.g., ineffective cooling or excess cooling). As such, the server 200 may operate to actively modify the proactive thermal management procedure to account for this change in thermal load. The present disclosure contemplates that the server 200 may dynamically modify the proactive thermal management procedure in response to any operation, action, state determination, operating parameter, or the like. Furthermore, the present disclosure contemplates that the iterative generation of proactive thermal management procedures may be used to improve subsequent performance parameter determination and/or packet processing core selection as described herein.

### Example Method for Processing Core Selection

FIG. 4 illustrates a flowchart containing a series of operations for processing core selection. The operations illustrated in FIG. 4 may, for example, be performed by, with the assistance of, and/or under the control of an apparatus (e.g., server 200), as described above. In this regard, performance of the operations may invoke one or more of processor 202, memory 206, and/or communication interface 204.

As shown in operation 402, the apparatus (e.g., server 200) includes means, such as processor 202, predictive cooling/workflow system 106, or the like, for receiving one or more operating characteristics of each of the plurality of processing cores 102a-n. As described above, the embodiments of the present disclosure may further select particular processing cores 102a-n for performing particular job packets based upon the operating characteristics of these processing cores. As described above, the present disclosure contemplates that the operational characteristics (e.g., current/expected thermal burden, current/expected processor/memory utilization, and/or the like) associated with these processing cores that may be relevant to performing the operations associated with the job packet. By way of a non-limiting example, the operating characteristics may include a processor utilization that may be any indicator representative of the processor's utilization of available resources for a specific packet processing core 102. In some embodiments, the processor utilization may represent the amount of time and/or clock cycles the processor is engaged in executing instructions in relation to the total time available. For example, the processor utilization parameter may indicate the packet processing core's utilization in instructions per cycle.

By way of an additional example, the one or more operating characteristics may contain a memory utilization parameter. The memory utilization parameter may be any indicator representative of the packet processing core's 102 utilization of available memory resources. In some embodiments, the memory utilization parameter may represent the amount of the packet processing core's memory in use at a given time. In some embodiments, the memory utilization may represent the utilization of volatile memory, non-volatile memory, or both volatile and non-volatile memory. By way of an additional example, the one or more operating characteristics may contain an operating temperature parameter. The operating temperature parameter may be any indicator of the temperature of the packet processing core during operation measured at any location on the packet processing core or may be a combination or average of a number of temperature readings to provide a spatial and/or temporal representation of the temperature of the packet processing core. The present disclosure contemplates that any attribute, parameter, characteristics, etc. associated with the processing cores 102a-n may be received at operation 402.

Thereafter, as shown in operation 404, the apparatus (e.g., server 200) includes means, such as processor 202, predictive cooling/workflow system 106, or the like, for determining a selected processing core 102 from amongst a plurality of processing cores 102a-n for the performance of the job packet. A described above, the current operating characteristics associated with the processing cores 102a-n may impact the ability of the processing cores 102a-n to complete the job packet and may further impact the thermal load or burden of the processing cores 102a-n. By way of example, a processing core 102 that has an elevated temperature and/or an increased processor utilization (e.g., overclocked or otherwise) may require additional cooling to properly dissipate heat generated in performance of the job packet. In contrast, an underutilized processor and/or relatively lower temperature may require less cooling (e.g., heat dissipation) such that the particular processing core 102 is more suited for performing the job packet. In other embodiments, the priority associated with competition of the job packet may necessitate use of a packet processing core that is at an elevated temperature or overutilized. In any implementation, the server 200 may determine the selected processing core based upon (e.g., as impacted by) the operating characteristics associated with the processing cores 102a-n.

Thereafter, as shown in operation 404, the apparatus (e.g., server 200) includes means, such as processor 202, communication interface 204, or the like, for transmitting the job packet to the selected processing core 102. In some embodiments, transmission of the job packet to the selected processing core 102 may cause performance of the proactive thermal management procedure. For example, transmission of the job packet to the selected processing core 102 may further include transmission of instructions to the thermal management devices 108 to cause and/or prepare to cause heat dissipation measures (e.g., cooling) to be disbursed. In other embodiments, the server 200 may transmit the proactive thermal management procedure to the thermal management device 108 in advance of transmission of the job packet to the selected processing unit 102. In doing so, the thermal management device 108 may operate to preemptively preparing cooling solutions that align with the thermal load of performance of the job packet.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed is:

1. A computer-implemented method for proactive thermal management and processing core selection, the method comprising:
receiving a job packet, wherein the job packet is associated with a packet profile;
determining one or more performance parameters associated with a performance of the job packet as defined by the packet profile;
generating a proactive thermal management procedure based upon the one or more performance parameters; and
associating the proactive thermal management procedure with the job packet.

2. The computer-implemented method of claim 1, further comprising:
determining a selected processing core from amongst a plurality of processing cores for the performance of the job packet; and
transmitting the job packet to the selected processing core.

3. The computer-implemented method of claim 2, wherein determining the selected processing core further comprises:
receiving one or more operating characteristics of each of the plurality of processing cores; and
determining the selected processing core based upon the one or more operating characteristics and the one or more performance parameters of the job packet.

4. The computer-implemented method of claim 2, wherein the proactive thermal management procedure is configured to cause dissipation of heat associated with the selected processing core that is generated in response to the performance of the job packet.

5. The computer-implemented method according to claim 2, wherein the proactive thermal management procedure is configured to dynamically modify a supplied cooling amount based upon variation in the one or more operating characteristics of the selected processing core during performance of the job packet.

6. The computer-implemented method according to claim 5, wherein a maximum supplied cooling amount coincides with a maximal thermal load of the selected processing core during performance of the job packet.

7. The computer-implemented method according to claim 2, further comprising modifying the proactive thermal management procedure in response to the performance of the job packet by the selected processing core.

8. A system comprising:
a plurality of processing cores; and
a thermal management unit communicatively connected to the plurality of processing cores, wherein the thermal management unit is configured to:
receive a job packet associated with a packet profile;
determine one or more performance parameters associated with a performance of the job packet as defined by the packet profile;
generate a proactive thermal management procedure based upon the one or more performance parameters; and
associate the proactive thermal management procedure with the job packet.

9. The system of claim 8, wherein the thermal management unit is further configured to:
determine a selected processing core from amongst the plurality of processing cores for the performance of the job packet; and
transmit the job packet to the selected processing core.

10. The system of claim 9, wherein, in determining the selected processing core, the thermal management unit is further configured to:
receive one or more operating characteristics of each of the plurality of processing cores; and
determine the selected processing core based upon the one or more operating characteristics and the one or more performance parameters of the job packet.

11. The system of claim 9, wherein the proactive thermal management procedure is configured to cause dissipation of heat associated with the selected processing core that is generated in response to the performance of the job packet.

12. The system of claim 9, wherein the proactive thermal management procedure is configured to dynamically modify a supplied cooling amount based upon variation in the one or more operating characteristics of the selected processing core during performance of the job packet.

13. The system of claim 12, wherein a maximum supplied cooling amount coincides with a maximal thermal load of the selected processing core during performance of the job packet.

14. The system of claim 9, wherein the thermal management unit is further configured to modify the proactive thermal management procedure in response to the performance of the job packet by the selected processing core.

15. A computer program product comprising at least one non-transitory computer-readable storage medium having computer program code thereon that, in execution with at least one processor, configures the computer program product for:
receiving a job packet, wherein the job packet is associated with a packet profile;
determining one or more performance parameters associated with a performance of the job packet as defined by the packet profile;
generating a proactive thermal management procedure based upon the one or more performance parameters; and
associating the proactive thermal management procedure with the job packet.

16. The computer program product of claim 15, the computer program product further configured for:
determining a selected processing core from amongst a plurality of processing cores for the performance of the job packet; and
transmitting the job packet to the selected processing core.

17. The computer program product of claim 16, wherein, in determining the selected processing core, the computer program product is further configured for:
receiving one or more operating characteristics of each of the plurality of processing cores; and
determining the selected processing core based upon the one or more operating characteristics and the one or more performance parameters of the job packet.

18. The computer program product of claim 16, wherein the proactive thermal management procedure is configured to cause dissipation of heat associated with the selected processing core that is generated in response to the performance of the job packet.

19. The computer program product of claim 16, wherein the proactive thermal management procedure is configured to dynamically modify a supplied cooling amount based upon variation in the one or more operating characteristics of the selected processing core during performance of the job packet.

20. The computer program product of claim 16, the computer program product further configured for modifying the proactive thermal management procedure in response to the performance of the job packet by the selected processing core.
